(19) United States
(12) Patent Application Publication
(10) Pub. No.: US 2011/0254863 A1
(43) Pub. Date: Oct. 20, 2011

(54) IN-VEHICLE DISPLAY DEVICE

(75) Inventor: Hitoshi HOSHINO, Nagoya-city (JP)

(73) Assignee: DENSO CORPORATION, Kariya-city (JP)

(21) Appl. No.: 13/079,839

(22) Filed: Apr. 5, 2011

(30) Foreign Application Priority Data
Apr. 14, 2010 (JP) 2010-93200

(51) Int. Cl. G09G 5/00

(52) U.S. Cl. 345/660

(57) ABSTRACT

An in-vehicle display device mounted on a vehicle includes: an application execution element for executing an application program; a display element for displaying an image according to a image display instruction input from the application execution element when the application execution element executes the application program; a determination element for determining whether a predetermined certification information is attached to the application program; and a change instruction input element for inputting a change instruction into the display element when the determination element determines that the predetermined certification information is not attached to the application program. The change instruction is one of an extension instruction and a size reduction instruction and the extension instruction provides to extend an update interval of the image, and the size reduction instruction provides to reduce a display region of the image.

### CROSS REFERENCE TO RELATED APPLICATION

This application is based on Japanese Patent Application No. 2010-93200 filed on Apr. 14, 2010, the disclosure of which is incorporated herein by reference.

### TECHNICAL FIELD

The present invention relates to an in-vehicle display device mounted on a vehicle for displaying various screen images based on various application programs.

### BACKGROUND

A display device in a navigation system mounted on a vehicle displays various screen images based on various application programs. Recently, the display device displays moving animation images as motion pictures. However, when the motion pictures are displayed during the vehicle runs, a driver may divert his attention. Thus, JP-A-2007-336211 teaches a technique that a time interval between two frames of the motion pictures increases when the vehicle runs so that the driver does not divert attention. One animation picture is updated to another animation picture, and an updating time interval provides the time interval between two animation pictures. However, for example, when an application process for displaying a map is executed, it is necessary to update the animation pictures successively. In this case, when the updating time interval becomes long, a proper function of the application process may not be accomplished. Accordingly, the above technique may not be applied to this type of process.

A certain application program is certificated as safe application program for providing to display a screen image, a content of which does not bother the driver so that the driver drives the vehicle safety even when the screen image is displayed. Based on the certified safe application program, the display displays screen images so that the safety drive of the vehicle is secured. However, recently, various programs are developed, and further, a device or a system for utilizing a program, which is available for the user freely, are developed. Accordingly, an application program other than the certified safe application programs may provide to display a screen image on the display device when the driver drives the vehicle. Specifically, not-certificated application program, which is not certificated as the safe application program may execute to display the screen images when the driver drives the vehicle.

### SUMMARY

In view of the above-described problem, it is an object of the present disclosure to provide an in-vehicle display device for displaying various screen images based on various application programs. The display device displays the images, which are ensured the safety even when a driver drives the vehicle, and the images are displayed according to not-certificated safe application program.

According to an aspect of the present disclosure, an in-vehicle display device mounted on a vehicle includes: an application execution element for executing an application program; a display element for displaying an image according to a image display instruction input from the application execution element when the application execution element executes the application program; a determination element for determining whether a predetermined certification information is attached to the application program; and a change instruction input element for inputting a change instruction into the display element when the determination element determines that the predetermined certification information is not attached to the application program. The change instruction is one of an extension instruction and a size reduction instruction, and the extension instruction provides to extend an update interval of the image, and the size reduction instruction provides to reduce a display region of the image.

In the above device, the display device displays the image, which is ensured safety even when a driver drives the vehicle, and the image is displayed according to not-certificated application program.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an in-vehicle display device;

FIG. 2 is a flowchart showing a control process in the display device; and

FIG. 3 is a flowchart showing a process for displaying an image according to a not-certificated application program.

### DETAILED DESCRIPTION

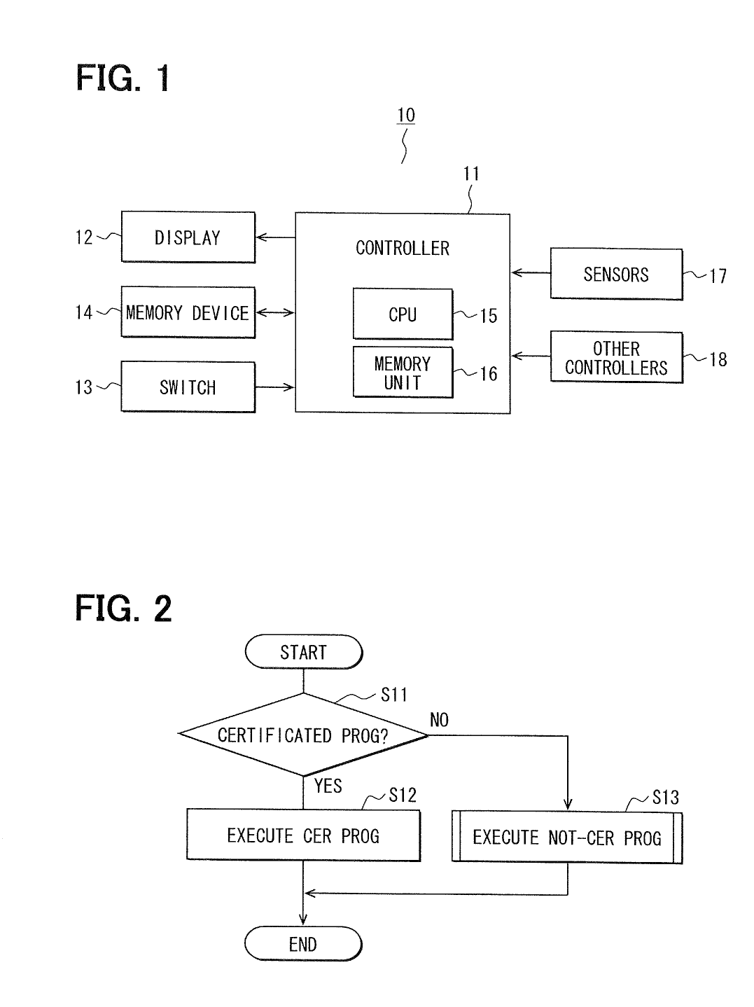

FIG. 1 shows an in-vehicle display device 10 mounted in a vehicle navigation, system, for example. The display device 10 includes a controller 11, a display element 12, operation switches 13 and a memory device 14. The controller 11 includes a micro computer and the like. The display element 12 includes a liquid crystal display. The operation switches 13 are operated by an user. The memory device 14 includes a hard disk drive. The controller 11 provides an application program executing element, a determining element, a change instruction output element, a driving condition determination element, a display possibility level determination element, a data size calculation element, and a display change level determination element. The display element 12 provides a display unit.

The controller 11 includes a CPU 15, a memory unit such as a RAM, a ROM, a EEPROM and a flash memory, an I/O interface (not shown) and the like. The controller 11 controls the CPU to execute a control program stored in the memory unit 16. Thus, the controller 11 controls a whole of operations in the display device 10. The controller 11 controls the CPU 15 to execute various application programs stored in the memory unit 16 for displaying screen images so that the controller 11 inputs a image display instruction signal into the display element 12. Accordingly, the controller 11 controls the screen images on the display element 12.

Various programs including the application program for displaying images may be preliminary stored in the memory unit 16 when the display device 10 is manufactured. Alternatively, various programs may include a program, which is received, i.e., down loaded from an external system via a data receiver (not shown), and then, stored in the memory unit 16. Alternatively, various programs may include a program, which is installed after the user buys the display device 10. The controller 11 distinguishes and executes certificated safe application programs and not-certificated safe application programs in the memory unit 16

A method for distinguishing the certificated safe application programs and not-certificated safe application programs is, for example, such that each certificated safe application program includes an identifier for providing the certification of safety, and the controller determines according to the identifier whether the application program is certificated. Alternatively, the distinguishing method may provide to determine whether the application program is downloaded from a server according to a security protocol, the server authorized to a safe server for serving certified application programs together with information that the program is certificated as a safe program, so that it is determined whether the application program is the certificated safe application program or the not-certificated safe application program. Alternatively, the distinguishing method may provide to distribute a certified application program together with a certification key showing that the program is certificated as a safe program, and to verify the certification key periodically or at certain certification intervals with information in the certification server, so that it is determined whether the application program is the certificated safe application program or the not-certificated safe application program. Thus, the distinguishing method provides to clearly distinguish the certificated application program together with certain certification information from the not-certificated application program not having the certain certification information.

The controller 11 is coupled with the sensors 17 and other controllers 18, which are mounted on respective in-vehicle devices. The controller 11 obtains various vehicle information such as vehicle speed information, shift lever information, information about a rotation angle of steering wheel, information about a braking degree of a brake pedal, information about an opening degree of an acceleration pedal and route guiding information of a navigation function, based on various signals input from the sensors 17 and the other controllers 18.

The display element 12 displays various screen images according to image display instruction signals output from the controller 11 based on execution of the application program for screen image display. The control method of the screen image display will be explained later. The micro computer as the CPU 15 and the image generation circuit execute the program for generating an image so that a process for generating the screen image on the display element 12 is executed. The process for generating the image on the display element 12 is executed by the micro computer as the CPU 15 in the controller 11, which performs the image generation program stored in the memory unit 16 of the controller 11.

The operation switches 13 include a mechanical switch disposed near the display panel of the display element 12 and a touch panel switch integrated on the display panel of the display element 12. The operations witches 13 include a display method selection switch for selecting a display method of the screen image. The operation switches 13 inputs various signals into the controller 11 according to the user operation.

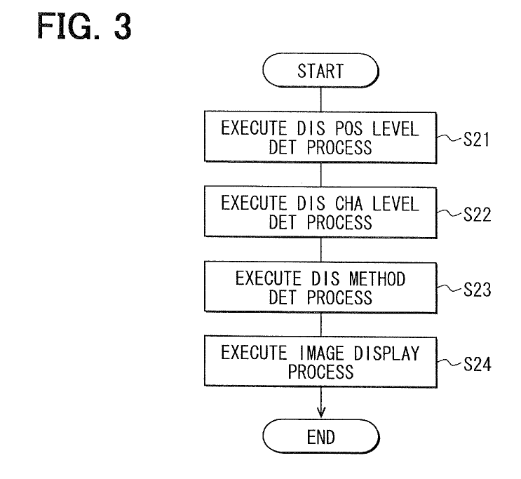

The in-vehicle display device 10 controls the display element 12 to change the display method of the screen image on the display element 12 based on the not-certificated application program when the application program to be executed by the controller 11 is not the certificated application program, i.e., when the application program is the not-certificated application program. Next, the control process of the controller 11 will be explained with reference to FIGS. 2 and 3.

FIG. 2 shows a flowchart showing the control process executed by the controller 11. The controller 11 determines in step S11 whether the application program for image display to be executed by the controller 11 is the certificated application program. Step S11 in the controller 11 corresponds to a determination element. In the determination step, one of the above described distinguishing methods is executed so that it is determined whether the certain certification information is attached to the application program.

The controller 11 executes a certificated application program display process in step S12 when the controller 11 determines that the application program for image display to be executed by the controller 11 is the certificated application program, i.e., when the controller 11 determines that the certain certification information is attached to the application program, i.e., when the determination in step S11 is “YES.” In the certificated application program display process, the controller 11 displays various screen images without changing the display method according to the image display instruction signal, which is output by executing the certificated application program.

The controller 11 executes a not-certificated application program display process in step S13 when the controller 11 determines that the application program for image display to be executed by the controller 11 is not the certificated application program, i.e., when the controller 11 determines that the certain certification information is not attached to the application program i.e., when the determination in step S11 is “NO.” FIG. 3 shows the not-certificated application program display process.

The controller 11 executes a display possibility level determination step in step S21. Step S21 corresponds to a display possibility level determination element. The display possibility level is a parameter for showing whether it is possible to display the screen image to be displayed on the display element according to the image display instruction signal even when the driver drives the vehicle, i.e., when the vehicle is moving. Specifically, the display possibility level shows the parameter of necessity for the driver to concentrate the vehicle driving or the parameter of allowance for the driver to see the image displayed on the display element 12 when the image is displayed on the display element 12 according to the image display instruction signal.

In the determination step in step S21, the controller 11 determines the display possibility level based on the driving condition of the vehicle. Specifically, the controller 11 determines based on various vehicle information whether the driving condition is an operation state, a stably driving state, or a parking state, the various vehicle information obtained by various signals input from the sensors 17 and other controllers 18. This step provides a driving condition determination element. Here, in the operation state, the driver operates a brake pedal, an acceleration pedal, a steering wheel or the like. In the stably driving state, the driver does not substantially operate the brake pedal, the acceleration pedal, the steering wheel or the like, for example, when the vehicle is moving on a high way. In the parking state the vehicle is completely parked i.e., the vehicle is not moving.

In the above case, when the controller 11 determines that the driving condition of the vehicle is the operation state, the controller 11 sets the display possibility level as “DANGER.” When the controller 11 determines that the driving condition of the vehicle is the stably driving state, the controller 11 sets the display possibility level to be “CAUTION.” When the controller 11 determines that the driving condition of the vehicle is the parking state, the controller 11 sets the display possibility level to be “SAFE”

Next, the controller 11 executes the determination process of the display image change level. Step S22 corresponds to a display change level determination element. The display change level is a parameter showing an amount of change of the screen image to be displayed on the element 12 according to the image display instruction signal.

Here, when the application program provides to display a motion picture of an animation image, the animation image is divided into multiple frames so that each frame is displayed. In order to reduce a memory utilization and a process load for executing the display process, the display element 12 redraws only a part of the image, which is changed from an initial image. Specifically, the part of the image is defined as a redraw region, a display content of which is different from a display content of a corresponding region of the initial image. Thus, the controller 11 determines the display change level based on the size of the image data corresponding to the redraw region. Specifically, the controller 11 calculates an integration value of the size of a part of the image data for redrawing the image in the redraw region during a predetermined period. All of the image data provides to redraw the images in the redraw region according to the image display instruction signal during a whole period. This step for calculating the integration value corresponds to a data size calculation element. The predetermined period can be any period in the whole period so that the predetermined period is a part of the whole period. The length of the predetermined period is, for example, a few seconds.

The controller 11 determines whether the integration value of the image data size summed up during the predetermined period exceeds a threshold value. When the integration value exceeds the threshold value the controller 11 determines that the amount of change of the screen image to be displayed on the element 12 is large, and therefore, the controller 11 determines that the change amount is in a “DANGER” state. Thus, in this case, the display change level is “DANGER.” When the integration value does not exceed the threshold value, the controller 11 determines that the amount of change of the screen image to be displayed on the element 12 is small, and therefore, the controller 11 determines that the change amount is in a “SAFE” state. Thus, in this case, the display change level is “SAFE.”

In the integration process of the image data size to be redrawn in the redraw region, a weighting factor may be attached according to a position of the redraw region on the screen image of the display element 12. Specifically, even when the redraw region has the same dimensions, and the redraw region is disposed on a driver seat side so that the redraw region comes into the driver's eye sight easily, the weighting factor of the redraw region is large, and therefore, the integration value calculated in step S22 becomes large. When the redraw region is disposed on a passenger seat side so that the redraw region does not come into the driver's eye sight easily, the weighting factor of the redraw region is small, and therefore the integration value calculated in step S22 becomes small.

Next, the controller 11 executes the display method determination process in step S23. Step S23 corresponds to a display method change instruction outputting element. In the determination process, the controller 11 changes the display method of the screen images based on the display possibility level and the display change level, the screen images being to be displayed on the display element 12 according to the image display instruction signal output by execution of the not-certificated application program, the display possibility level determined in the display possibility level determination process in step S21, and the display change level determined in the display change level determination process in step S22. Specifically, the controller 11 automatically selects one of the frame rate changing method the display size changing method and a combination of the frame rate changing method and the display size changing method when the display possibility level is “DANGER,” and the display change level is “DANGER.” Then, the controller 11 switches the display method of the image to be the selected method. Here, the frame rate changing method provides such that the controller 11 inputs the extension instruction signal as the display method change instruction signal into the display element 12 so that the update interval of the image display to be displayed on the display element 12 according to the image display instruction signal, which is defined as a frame rate, is extended from a normal frame rate defined by the application program. The display size change method provides such that the controller 11 inputs the size reduction instruction signal as the display method change instruction signal into the display element 12 so that the display region of the screen image to be displayed on the display element 12 according to the image display instruction signal is reduced from the normal display region defined by the application program. The combination of the frame rate change method and the display size change method provides such that the controller 11 inputs the display method change instruction signal into the display element 12 so that the frame rate is extended and the display region of the image is reduced.

Next the controller 11 executes the image display process in step S24. In the display process, the controller 11 controls the display element 12 to display various images based on the changed display method switched in the display method determination process in step S23. Specifically, the controller 11 executes the display process with changing the image display method according to the image display instruction to the image display method, which provides safety even when the driver drives the vehicle.

The controller 11 controls the display element 12 to display various images in step S24 without changing the display method when the display possibility level is “SAFE,” and the display change level is “SAFE.”

Thus, in the present embodiment, when the application program to be executed by the controller 11 is not the certificated application program, which includes the certain certification information i.e., when the application program is the not-certificated application program not having the certain certification information, the image display method of the images to be displayed on the display element 12 according to the not-certificated application program is switched to one of the frame rate change method for extending the update interval of the image, the display size changing method for reducing the display region of the image and a combination of the frame rate change method and the display size change method. Thus, even when the controller 11 executes the not-certificated application program, which is not certificated as the safe application program for driving the vehicle, the controller 11 controls the display element 12 to display the screen image.

Further, various images to be displayed on the element 12 according to the not-certificated application program is displayed by the display method modified in view of the display possibility level and the display change level the display possibility level showing whether it is possible to display the image, and the display change level showing the amount of change of the screen image. Thus, the image can be displayed with securing safety of the driving when the vehicle is moving.

In the above in-vehicle display device, the controller 11 automatically selects one of the frame rate changing method, the display size changing method and a combination of the frame rate changing method and the display size changing method. Alternatively, the user may operate a display method selection switch among the operation switches 13 so that the user can select one of the extension instruction signal and the size reduction instruction signal as the display method change instruction signal to be input into the display element 12 from the controller 11. In this case, even when the driver drives the vehicle, the user can operate the display method selection switch so that the user can select the image display method easily.

In the above case, the controller 11 may store information for specifying the display method change instruction signal selected by the user via the display method selection switch, or information for specifying the display method corresponding to the display method change instruction signal, together with the display possibility level and the display change level into the memory device 14, the display possibility level and the display change level being defined at a time when the display method is selected by the user. The controller 11 may change the image display method such that the controller 11 sets one of the extension instruction signal and the size reduction instruction signal as the display method change instruction signal to be input into the display element 12 based on the information record for specifying the display method change instruction signal stored in the memory device 14 or the information record for specifying the display method corresponding to the display method change instruction signal. In this case, the image to be displayed on the display element 12 based on the not-certificated application program can be displayed with the display method, which has been selected previously by the user. Specifically, the user can control the display element 12 to display the image in view of the preference of the user.

The operation switches 13 may include a setting switch for setting an extension time of the update interval of the image display in the frame rate change method. Alternatively, the switches 13 may include a setting switch for setting the reduction amount of the display region of the image in the display size change method. The controller 11 may store the set extension time of the update interval of the image display and/or the set reduction amount of the display region of the image into the memory device 14.

Thus, the memory device 14 stores the record of the display method, which is selected by the user. Based on the record, the controller 11 obtains information about a relationship among the selected display method, the application program having the display change level and the display possibility level. Further, the controller 11 obtains information such that the user sets to restrict the change of the image or the user sets to accept the change of the image with respect to the extension amount of the update interval of the image display and the reduction amount of the display region of the image.

When the user sets to accept the change of the image, it is considered that the user recognizes that the display content of the application program has high utility value. Thus, the user setting to accept the change of the image has tolerance with respect to the change of the image, compared with the user who does not utilize the display content of the application program. Thus, the feeling with respect to the image change depends on the user. Accordingly, the controller 11 may change the threshold value for determining the display possibility level and the weighting factor of the position of the redraw region based on the information record stored in the memory device 14. Specifically, the controller 11 sets the threshold value for determining the display possibility level to be lower when the operation of the user tends to reduce the image change. On the other hand, the controller 11 sets the threshold value for determining the display possibility level to be higher when the operation of the user tends to accept the image change.

Thus, images to be displayed on the display element 12 based on the application program can be displayed by the display method modified in view of the user preference.

When the frame rate change method is selected, the update interval of the image display, i.e., the frame rate becomes long, so that the period of the update of the screen image is long. On the other hand, the instruction in the application program may include instructions other than the display instructions. In the present embodiment, the update interval of the instruction other than the display instructions is not changed.

Accordingly, the controller 11 may ignore the image generation instruction based on the application program so that the controller 11 does not generate the image data until the period of the instruction other than the display instructions to be output from the controller 11 has elapsed when the frame rate change method is selected, and the period of the extension instruction signal to be input into the element 12 based on the update interval of the image display after the update interval is changed is shorter than the period of the instruction other than the display instruction to be output from the controller 11. After the period of the instruction other than the display instructions to be output from the controller 11 has elapsed, the controller 11 generate the image data, and then, the controller inputs the image data into the display element 12.

Alternatively, the controller 11 may generate the image data according to the image generation instruction based on the application program, and ignore the image data transmission instruction based on the application program until the period of the instruction other than the display instructions to be output from the controller 11 has elapsed when the frame rate change method is selected, and the period of the extension instruction signal to be input into the element 12 based on the update interval of the image display after the update interval is changed is shorter than the period of the instruction other than the display instruction to be output from the controller 11. After the period of the instruction other than the display instructions to be output from the controller 11 has elapsed, the controller 11 inputs the image data into the display element 12.

The controller 11 may generate the image data having the image size, smaller than the normal image size defined in the application program, according to the display region of the image after the display size is changed when the display size change method is selected. Alternatively, the controller 11 may execute a compression process for compressing the image data of the normal image generated by the application program so that the image data having the image size corresponding to the display region after the display size is changed is formed.

An image data showing a safe image and provided by an icon is preliminary generated. The icon is simplified so that the driver does not divert his/her attention to the icon even when the icon is displayed while the vehicle is moving. The controller 11 may transmit the image data of the safe image, together with the image data of the screen image to be displayed in the redraw region to the display element 12.

In the above embodiment, the driving condition of the vehicle when the display possibility level is determined is one of the operation state, the stably driving state and the parking state. Alternatively, the driving condition may include other states such as a low speed driving state.

In the above embodiment, the controller 11 automatically selects one of the frame rate changing method, the display size changing method and combination of the frame rate changing method and the display size changing method. Alternatively, the user may preliminary set one of the frame rate changing method, the display size changing method and their combination in each application program so that the controller 11 selects the one of the frame rate changing method, the display size changing method and their combination.

For example, the user may set the controller to select the frame rate change method when the display possibility level is “DANGER,” and the display change level is “DANGER.” The user may set the controller to select the display size change method when the display possibility level is “CAUTION,” and the display change level is “DANGER.”

The above disclosure has the following aspects.

According to an aspect of the present disclosure, an in-vehicle display device mounted on a vehicle includes: an application execution element for executing an application program; a display element for displaying an image according to a image display instruction input from the application execution element when the application execution element executes the application program; a determination element for determining whether a predetermined certification information is attached to the application program; and a change instruction input element for inputting a change instruction into the display element when the determination element determines that the predetermined certification information is not attached to the application program. The change instruction is one of an extension instruction and a size reduction instruction, and the extension instruction provides to extend an update interval of the image, and the size reduction instruction provides to reduce a display region of the image.

In the above device, the display device displays the image, which is ensured safety even when a driver drives the vehicle, and the image is displayed according to not-certificated application program.

Alternatively, the in-vehicle display device may further include: a driving condition determination element for determining a driving condition of a vehicle; a display possibility level determination element for determining a display possibility level based on the driving condition, wherein the display possibility level shows whether it is possible to display the image; a data size calculation element for calculating a data size of the image; and a display change level determination element for determining a display change level based on the data size wherein the display change level shows a change amount of the image.

The change instruction input element selects the one of the extension instruction and the size reduction instruction based on the display change level and the display possibility level. In this case, the safety of the driver is much ensured.

Further, the image may include a motion picture having a plurality of image frames so that the display element displays the plurality of image frames in sequence, and the update interval is defined by a display time interval between two adjacent image frames.

Furthermore, the display element may display the image according to the image display instruction without changing a display condition when the determination element determines that the predetermined certification information is attached to the application program, and the display condition includes the update interval of the image and the display region of the image.

Further, the driving condition may include a driver operation state, a stably driving state and a vehicle parking state. The driving condition determination element determines that the driving condition is the driver operation state when a driver of the vehicle operates one of a brake pedal, an acceleration pedal and a steering wheel. The driving condition determination element determines that the driving condition is the stably driving state when the driver drives the vehicle stationary. The driving condition determination element determines that the driving condition is the vehicle parking state when the vehicle is parked. The display possibility level determination element determines that the display possibility level is low when the driving condition is the driving operation state. The display possibility level determination element determines that the display possibility level is intermediate when the driving condition is the stably driving state. The display possibility level determination element determines that the display possibility level is high when the driving condition is the vehicle parking state.

Further, the display change level determination element may determine that the display change level is high when the change amount of the image is larger than a predetermined threshold value, and the display change level determination element may determine that the display change level is low when the change amount of the image is equal to or smaller than a predetermined threshold value.

Further, the change instruction input element may select the one of the extension instruction and the size reduction instruction when the display change level is high and the display possibility level is low, and the change instruction input element does not input the change instruction into the display element when the display change level is low and the display possibility level is high.

While the invention has been described with reference to preferred embodiments thereof, it is to be understood that the invention is not limited to the preferred embodiments and constructions. The invention is intended to cover various modification and equivalent arrangements. In addition, while the various combinations and configurations which are preferred, other combinations and configurations, including more, less or only a single element, are also within the spirit and scope of the invention.

What is claimed is:

1. An in-vehicle display device mounted on a vehicle comprising:
an application execution element for executing an application program;
a display element for displaying an image according to a image display instruction input from the application execution element when the application execution element executes the application program;
a determination element for determining whether a predetermined certification information is attached to the application program; and
a change instruction input element for inputting a change instruction into the display element when the determination element determines that the predetermined certification information is not attached to the application program,
wherein the change instruction is one of an extension instruction and a size reduction instruction, and
wherein the extension instruction provides to extend an update interval of the image, and the size reduction instruction provides to reduce a display region of the image.

2. The in-vehicle display device according to claim further comprising:
a driving condition determination element for determining a driving condition of a vehicle;
a display possibility level determination element for determining a display possibility level based on the driving condition, wherein the display possibility level shows whether it is possible to display the image;
a data size calculation element for calculating a data size of the image; and
a display change level determination element for determining a display change level based on the data size wherein the display change level shows a change amount of the image,
wherein the change instruction input element selects the one of the extension instruction and the size reduction instruction based on the display change level and the display possibility level.

3. The in-vehicle display device according to claim 2,
wherein the image includes a motion picture having a plurality of image frames so that the display element displays the plurality of image frames in sequence, and
wherein the update interval is defined by, a display time interval between two adjacent image frames.

4. The in-vehicle display device according to claim 3,
wherein the display element displays the image according to the image display instruction without changing a display condition when the determination element determines that the predetermined certification information is attached to the application program, and
wherein the display condition includes the update interval of the image and the display region of the image.

5. The in-vehicle display device according to claim 4,
wherein the driving condition includes a driver operation state a stably driving state and a vehicle parking state,
wherein the driving condition determination element determines that the driving condition is the driver operation state when a driver of the vehicle operates one of a brake pedal, an acceleration pedal and a steering wheel,
wherein the driving condition determination element determines that the driving condition is the stably driving state when the driver drives the vehicle stationary,
wherein the driving condition determination element determines that the driving condition is the vehicle parking state when the vehicle is parked,
wherein the display possibility level determination element determines that the display possibility level is low when the driving condition is the driving operation state,
wherein the display possibility level determination element determines that the display possibility level is intermediate when the driving condition is the stably driving state, and
wherein the display possibility level determination element determines that the display possibility level is high when the driving condition is the vehicle parking state.

6. The in-vehicle display device according to claim 5,
wherein the display change level determination element determines that the display change level is high when the change amount of the image is larger than a predetermined threshold value, and
wherein the display change level determination element determines that the display change level is low when the change amount of the image is equal to or smaller than a predetermined threshold value.

7. The in-vehicle display device according to claim 6,
wherein the change instruction input element selects the one of the extension instruction and the size reduction instruction when the display change level is high and the display possibility level is low, and
wherein the change instruction input element does not input the change instruction into the display element when, the display change level is low and the display possibility level is high.
